(19) United States
(12) Patent Application Publication
(10) Pub. No.: US 2026/0178019 A1
(43) Pub. Date: Jun. 25, 2026

(54) CONTROLLING ENTITIES BY RE-BASELINING PROTOCOL DATA

(71) Applicant: International Business Machines Corporation, Armonk, NY (US)

(72) Inventors: Jennifer Marie Hatfield, Portland, OR (US); Martin G. Keen, Cary, NC (US); Sarbajit Kumar Rakshit, Kolkata (IN); Carolina Garcia Delgado, Zapopan (MX)

(21) Appl. No.: 18/989,057

(22) Filed: Dec. 20, 2024

(51) Int. Cl. G05B 19/418

(52) U.S. Cl. CPC G05B 19/41885; G05B 19/4184

(57) ABSTRACT

Controlling physical entities by re-baselining protocol data includes simulating one or more activities of a physical environment based on a digital twin model of the physical environment. Based on the simulation, an anomaly associated with the one or more activities executed by each physical entity of the plurality of the physical entities is identified. The protocol data is updated based on the identified anomaly to control at least one of the plurality of entities. Virtual environment data is generated for the physical environment rendered on a user device to facilitate workers to adjust based on the updated protocol data.

### BACKGROUND

The disclosure relates to industrial safety and security systems and more particularly, to controlling entities by re-baselining protocol data.

Industrial environments are complex environments owing to the presence of a wide range of machines and processes critical for different manufacturing operations. In such industrial environments, ensuring the safety and security of both the machines and the workforce is of utmost priority. Traditionally, industrial safety and security systems have focused on safeguarding the workforce, protecting assets, and maintaining continuity of operations within the industrial environment. Further, the industrial safety and security systems are designed to mitigate risks associated with workplace hazards, machinery malfunctioning, and the like. To achieve this, the industrial safety and security systems employ safety protocols and protective equipment, thereby creating a safe and secure workplace.

### SUMMARY

According to an embodiment of the disclosure, a computer-implemented method for controlling entities by re-baselining protocol data is described. The computer-implemented method includes simulating, by a computer, one or more activities of a physical environment based on a digital twin model of the physical environment. The one or more activities are executed by each physical entity of a plurality of physical entities within the physical environment. The computer-implemented method further includes identifying, by the computer, an anomaly associated with at least one of the one or more activities based on the simulation and protocol data The computer-implemented method further includes determining, by the computer, anomaly data associated with the anomaly based on the simulation and protocol data. The computer-implemented method includes updating, by the computer, the protocol data based on the anomaly data. Further, the computer-implemented method includes controlling, by the computer, at least one of the plurality of physical entities based on the updated protocol data.

According to one or more embodiments of the disclosure, a computer system for controlling entities by re-baselining protocol data is described. The computer system includes a processor set, one or more computer-readable storage media, and program instructions stored on the one or more computer-readable storage media. The program instructions executable by the processor set cause the processor set to simulate one or more manufacturing processes of an industrial environment based on a digital twin model of the industrial environment. The one or more manufacturing processes are executed by each machine of a plurality of machines within the industrial environment. The program instructions cause the processor set to identify an anomaly associated with at least one of the one or more manufacturing processes based on the simulation and protocol data The program instructions further cause the processor set to determine anomaly data associated with the anomaly based on the simulation and protocol data. The program instructions further cause the processor set to update the protocol data based on the anomaly data. Further, the program instructions cause the processor set to control at least one of the plurality of machines based on the updated protocol data.

According to one or more embodiments of the disclosure, a computer-program product for controlling a plurality of physical entities is described. The computer program product includes one or more computer-readable storage media, and program instructions stored on the one or more computer-readable storage media to perform operations including simulating one or more activities of a physical environment based on a digital twin model of the physical environment. The one or more activities are executed by each physical entity of the plurality of physical entities within the physical environment. The operations include identifying an anomaly associated with at least one of the one or more activities based on the simulation and protocol data. The operations include determining anomaly data associated with the anomaly based on the simulation and the protocol data. The operations include updating the protocol data based on the anomaly data. Further, the operations include controlling at least one of the plurality of physical entities based on the updated protocol data.

Additional technical features and benefits are realized through the techniques of the disclosure. Embodiments and aspects of the disclosure are described in detail herein and are considered a part of the claimed subject matter. For a better understanding, refer to the detailed description and the drawings.

### BRIEF DESCRIPTION OF THE DRAWINGS

The following description will provide details of preferred embodiments with reference to the following figures wherein:

FIG. 1 is a diagram that illustrates a computing environment for controlling physical entities by re-baselining protocol data, in accordance with an embodiment of the disclosure;

FIG. 2A is a diagram that illustrates an environment for controlling physical entities within a physical environment by re-baselining protocol data, in accordance with an embodiment of the disclosure;

FIG. 2B is a diagram that illustrates an exemplary environment for controlling the physical entities within the physical environment by re-baselining the protocol data, in accordance with an embodiment of the disclosure;

FIG. 3 is a block diagram that illustrates an exemplary operation for controlling the physical entities within the physical environment by re-baselining the protocol data, in accordance with an embodiment of the disclosure;

FIG. 4 is a block diagram that illustrates an exemplary operation for rendering virtual environment data based on updated protocol data, in accordance with an embodiment of the disclosure;

FIG. 5A is a diagram that illustrates an exemplary diagram of virtual environment data associated with the physical environment, in accordance with an embodiment of the disclosure;

FIG. 5B is a diagram that illustrates an exemplary diagram of the virtual environment data associated with the physical environment, in accordance with an embodiment of the disclosure; and

FIG. 6 is a flow chart that illustrates an exemplary method for controlling the physical entities by re-baselining the protocol data, in accordance with an embodiment of the disclosure.

### DETAILED DESCRIPTION

Machines in an industrial environment are interconnected and often share resources such as, but not limited to, power sources, control systems, or safety interlocks. For example, when a machine utilizing certain shared resources, such as a power or a control system, experiences a malfunction or failure, then safety issues may also arise with other nearby machines. For example, the malfunction or failure of the machine may interrupt the operation of other nearby machines within the industrial environment, thereby disrupting the workflow of the machines. For example, the interconnected control system shared amongst the machine and other machines may further amplify the security risk as a problem in the control system of the machine may destabilize the other machines in the industrial environment. In certain cases, the malfunction in the machine may trigger a chain reaction, delayed responses, loss of functionality, and safety risks in other machines. For example, a breakdown occurring in the machine may lead to congestion, overloading, or unsafe conditions in the workflow of the machines due to a chain reaction. Additionally, the malfunction or failure of the machine may cause an accident or a delay in production. For example, during troubleshooting the malfunction or failure of the machine, an operator may be distracted, thereby causing lapses in attention to nearby machines and increasing the risk of accidents. Further, human error during manual overrides or adjustments to malfunctioning machines may unintentionally affect other machines, compromising overall safety. Additionally, delays in addressing malfunctions may force other machines to compensate, thereby leading to operational stress, overuse, and potential breakdown. Further, maintenance or repair work on the machine that is malfunctioning often requires shutting down the machine or isolating the machine from the system, thereby leading to new safety risks as other machines adjust to the loss of functionality.

To mitigate such safety concerns, there is a need to have robust safety protocols, redundancy systems, and regular maintenance in place. Additionally, advanced technologies like predictive maintenance and automated safety systems can help minimize the impact of problems of one machine on others in the same environment.

Traditional safety protocols in industrial settings are often static and fail to adapt to evolving or unforeseen threats. There is a need for a system that can dynamically assess and recalibrate security protocols and operational parameters in response to detected issues on the industrial floor. The proposed system recognizes the complexities in modern industrial environments where problems in one machine may adversely affect others through shared resources, chain reactions, operator distraction, delayed responses, interconnected control systems, human error, and the need for maintenance or repair.

According to an embodiment of the disclosure, a computer-implemented method for controlling entities by re-baselining protocol data is described. The computer-implemented method includes simulating, by a computer, one or more activities of a physical environment based on a digital twin model of the physical environment. The one or more activities are executed by each physical entity of a plurality of physical entities within the physical environment. The computer-implemented method further includes identifying, by the computer, an anomaly associated with at least one of the one or more activities based on the simulation and protocol data The computer-implemented method further includes determining, by the computer, anomaly data associated with the anomaly based on the simulation and protocol data. The computer-implemented method includes updating, by the computer, the protocol data based on the anomaly data. Further, the computer-implemented method includes controlling, by the computer, at least one of the plurality of physical entities based on the updated protocol data.

In one or more embodiments of the disclosure, the computer-implemented method further includes obtaining, by the computer, activity data associated with each activity of the one or more activities executed by each physical entity of the plurality of physical entities. The computer-implemented method further includes generating, by the computer, the digital twin model of the physical environment based on the activity data and the protocol data. The digital twin model includes a virtual representation of each physical entity of the plurality of physical entities. The computer-implemented method further includes simulating, by the computer, each activity of the one or more activities based on the activity data and the digital twin model.

In one or more embodiments of the disclosure, the computer-implemented method further includes obtaining, by the computer, operational data associated with each physical entity of the plurality of physical entities. The computer-implemented method further includes obtaining, by the computer, environmental data associated with the physical environment. The computer-implemented method further includes generating, by the computer, the digital twin model of the physical environment based on the operational data and the environmental data.

In one or more embodiments of the disclosure, the computer-implemented method further includes analyzing, by the computer, the simulation, and a historical simulation. The computer-implemented method further includes determining, by the computer, deviation data associated with the simulation based on the analysis. The computer-implemented method further includes determining, by the computer, the anomaly data associated with the anomaly based on the deviation data.

In one or more embodiments of the disclosure, the anomaly is associated with at least one of malfunctioning of at least one of the plurality of physical entities, a safety threat associated with at least one of the plurality of physical entities, and a maintenance requirement associated with the at least one of the plurality of physical entities.

In one or more embodiments of the disclosure, the protocol data includes operating parameter data associated with each physical entity of the plurality of physical entities, operating zone data associated with an operation of each physical entity of the plurality of physical entities, and movement data associated with one or more users within the physical environment.

In one or more embodiments of the disclosure, the computer-implemented method further includes determining, by the computer, an operating zone associated with the operation of each physical entity of the plurality of physical entities based on the operating zone data. The computer-implemented method further includes determining, by the computer, a distance of the one or more users from the operating zone based on the movement data. The computer-implemented method further includes identifying, by the computer, the anomaly based on the distance. The computer-implemented method further includes determining, by the computer, the anomaly data based on the anomaly.

In one or more embodiments of the disclosure, the updated protocol data includes at least one of updated operating parameter data associated with each physical entity of the plurality of physical entities, updated operating zone data associated with an operation of each physical entity of the plurality of physical entities, or updated movement data associated with one or more users within the physical environment.

In one or more embodiments of the disclosure, the computer-implemented method further includes obtaining, by the computer, visual information visual data associated with the physical environment. The visual data includes object data associated with each physical entity of the plurality of physical entities. The computer-implemented method further includes generating, by the computer, virtual environment data based on the visual data, and the digital twin model. The virtual environment data includes a virtual representation of the execution of each activity of the one or more activities. The computer-implemented method further includes rendering, by the computer, the virtual environment data on a user device.

In one or more embodiments of the disclosure, the computer-implemented method further includes updating, by the computer, the virtual environment data based on the updated protocol data. The computer-implemented method further includes rendering, by the computer, the updated virtual environment data on the user device.

In one or more embodiments of the disclosure, the plurality of physical entities within the physical environment corresponds to a plurality of machines within an industrial environment.

According to one or more embodiments of the disclosure, a computer system for controlling entities by re-baselining protocol data is described. The computer system includes a processor set, one or more computer-readable storage media, and program instructions stored on the one or more computer-readable storage media. The program instructions executable by the processor set cause the processor set to simulate one or more manufacturing processes of an industrial environment based on a digital twin model of the industrial environment. The one or more manufacturing processes are executed by each machine of a plurality of machines within the industrial environment. The program instructions cause the processor set to identify an anomaly associated with at least one of the one or more manufacturing processes based on the simulation and protocol data. The program instructions cause the processor set to determine anomaly data associated with the anomaly based on the simulation and protocol data. The program instructions cause the processor set to update the protocol data based on the anomaly data. Further, the program instructions cause the processor set to control at least one of the plurality of machines based on the updated protocol data.

In one or more embodiments of the disclosure, the program instructions cause the processor set to obtain manufacturing process data associated with each manufacturing process of the one or more manufacturing processes executed by each machine of the plurality of machines. The program instructions cause the processor set to generate the digital twin model of the industrial environment based on the manufacturing process data and the protocol data. The digital twin model includes a virtual representation of each machine of the plurality of machines. The program instructions cause the processor set to simulate each manufacturing process of the one or more manufacturing processes based on the manufacturing process data and the digital twin model.

In one or more embodiments of the disclosure, the program instructions cause the processor set to obtain operational data associated with each machine of the plurality of machines. The program instructions cause the processor set to obtain environmental data associated with the industrial environment. The program instructions cause the processor set to generate the digital twin model of the industrial environment based on the operational data and the environmental data.

In one or more embodiments of the disclosure, the program instructions cause the processor set to analyze the simulation and a historical simulation. The program instructions cause the processor set to determine deviation data associated with the simulation based on the analysis. The program instructions cause the processor set to determine the anomaly data associated with the anomaly based on the deviation data.

In one or more embodiments of the disclosure, the protocol data includes operating parameter data associated with each machine of the plurality of machines, operating zone data associated with an operation of each machine of the plurality of machines, and movement data associated with one or more users within the industrial environment.

In one or more embodiments of the disclosure, the program instructions cause the processor set to determine an operating zone associated with the operation of each machine of the plurality of machines based on the operating zone data. The program instructions cause the processor set to determine a distance of the one or more users from the operating zone based on the movement data. The program instructions cause the processor set to identify the anomaly based on the distance. The program instructions cause the processor set to determine the anomaly data based on the anomaly.

In one or more embodiments of the disclosure, the program instructions cause the processor set to obtain visual data associated with the industrial environment. The visual data includes object data associated with each machine of the plurality of machines. The program instructions cause the processor set to generate virtual environment data based on the visual data, and the digital twin model. The virtual environment data includes a virtual representation of the execution of each manufacturing process of the one or more manufacturing processes. The program instructions cause the processor set to render the virtual environment data on a user device.

In one or more embodiments of the disclosure, the program instructions cause the processor set to update the virtual environment data based on the updated protocol data. The program instructions cause the processor set to render the updated virtual environment data on the user device.

According to one or more embodiments of the disclosure, a computer-program product for controlling a plurality of physical entities is described. The computer program product includes one or more computer-readable storage media, and program instructions stored on the one or more computer-readable storage media to perform operations including simulating one or more activities of a physical environment based on a digital twin model of the physical environment. The one or more activities are executed by each physical entity of the plurality of physical entities within the physical environment The operations include identifying an anomaly associated with at least one of the one or more activities based on the simulation and protocol data. The operations include determining anomaly data associated with the anomaly based on the simulation and the protocol data. The operations include updating the protocol data based on the anomaly data. Further, the operations include controlling at least one of the plurality of physical entities based on the updated protocol data.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium is an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

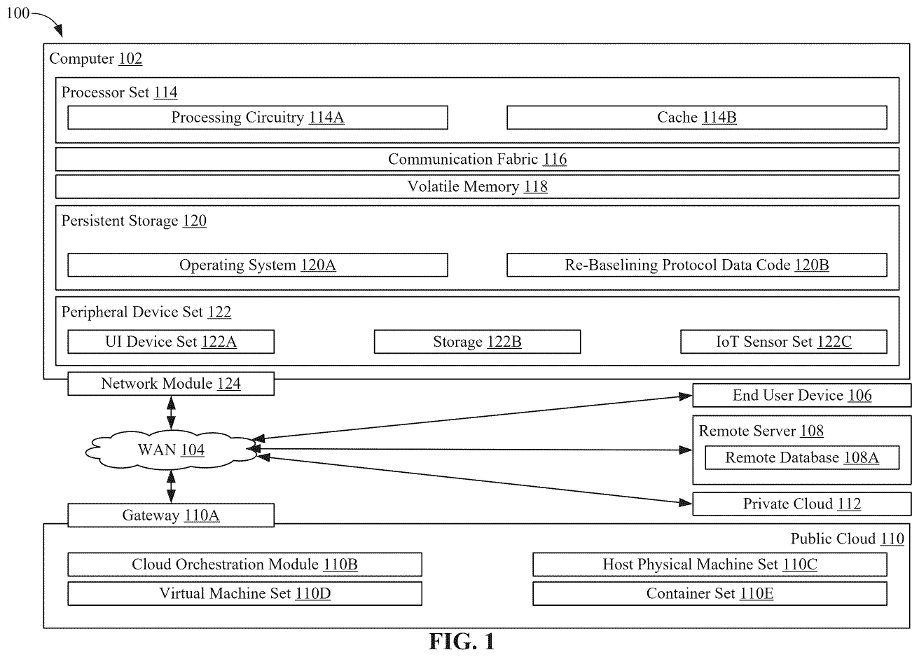

FIG. 1 is a diagram that illustrates a computing environment for controlling physical entities by re-baselining protocol data, in accordance with an embodiment of the disclosure. With reference to FIG. 1, there is shown a computing environment 100 that contains an example of an environment for the execution of at least some of the computer code involved in performing the disclosed methods, such as a re-baselining protocol data code 120B for recalibrating security protocols. In addition to the re-baselining protocol data code 120B, computing environment 100 includes, for example, a computer 102, a wide area network (WAN) 104, an end-user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the re-baselining protocol data code 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch, a robot, or other wearable computer, a mainframe computer, a quantum computer, or any other form of a computer or a mobile device now known or to be developed in the future that is capable of running a program, accessing a network or querying a database, such as a remote database 130. As is well understood in the art of computer technology, and depending upon the technology, the performance of a computer-implemented method is distributed among multiple computers and/or between multiple locations. On the other hand, in this presentation of the computing environment 100, detailed discussion is focused on a single computer, specifically the computer 102, to keep the presentation as simple as possible. The computer 102 is located in a cloud, even though it is not shown in a cloud in FIG. 1. On the other hand, the computer 102 is not required to be in a cloud except to any extent as is affirmatively indicated.

The processor set 114 includes one, or more, computer processors of any type now known or to be developed in the future. The processing circuitry 114A is distributed over multiple packages, for example, multiple, coordinated integrated circuit chips. The processing circuitry 114A may implement multiple processor threads and/or multiple processor cores. The cache 114B is a memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 is located “off-chip.” In some computing environments, the processor set 114 is designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in several types of computer-readable storage media, such as the cache 114B and the other storage media discussed below. The program instructions, and associated data, are accessed by the processor set 114 to control and direct the performance of the disclosed methods. In computing environment 100, at least some of the instructions for performing the disclosed methods are stored in the dynamic modification of the re-baselining protocol data code 120B in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, physical input/output ports, and the like. Other types of signal communication paths are used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not required unless affirmatively indicated. In the computer 102, the volatile memory 118 is located in a single package and is internal to the computer 102, but alternatively or additionally, the volatile memory 118 is distributed over multiple packages and/or located externally with respect to the computer 102.

The persistent storage 120 is any form of non-volatile storage for computers that is now known or to be developed in the future. The non-volatility of this storage means that the stored data is maintained regardless of whether power is being supplied to the computer 102 and/or directly to the persistent storage 120. The persistent storage 120 is a read-only memory (ROM), but typically at least a portion of the persistent storage 120 allows writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The re-baselining protocol data code 120B included in the re-baselining protocol data typically includes at least some of the computer code involved in performing the disclosed methods.

The peripheral device set 122 includes the set of peripheral devices of the computer 102. Data communication connections between the peripheral devices and the other components of the computer 102 are implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B is persistent and/or volatile. In some embodiments of the disclosure, storage 122B may take the form of a quantum computing storage device for storing data in the form of qubits. In embodiments of the disclosure where the computer 102 is required to have a large amount of storage (for example, where the computer 102 locally stores and manages a large database) then this storage is provided by peripheral storage devices designed for storing very large amounts of data, such as a storage area network (SAN) that is shared by multiple, geographically distributed computers. The IoT sensor set 122C is made up of sensors that can be used in Internet of Things applications. For example, one sensor is a thermometer, and another sensor is a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In one or more embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments of the disclosure, the WAN 104 is replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates the computer 102) and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present recommendations to an end user. In some embodiments of the disclosure, the EUD 106 is a client device, such as a thin client, heavy client, mainframe computer, desktop computer, and so on.

The remote server 108 is any computer system that serves at least some data and/or functionality to the computer 102. The remote server 108 is controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data is provided to the computer 102 from the remote database 130 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs are stored as images and are transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through the WAN 104.

VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in one or more embodiments of the disclosure, a private cloud is disconnected from the internet entirely and only accessible through a local/private network. A hybrid cloud is a composition of multiple clouds of diverse types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

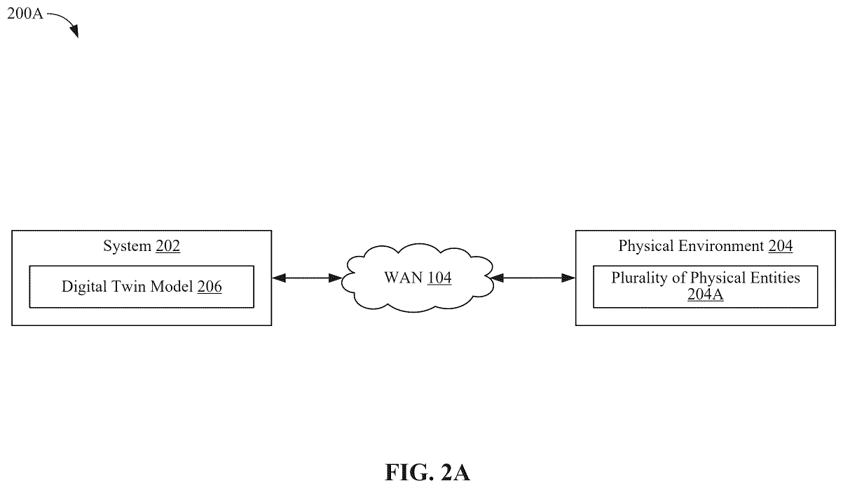

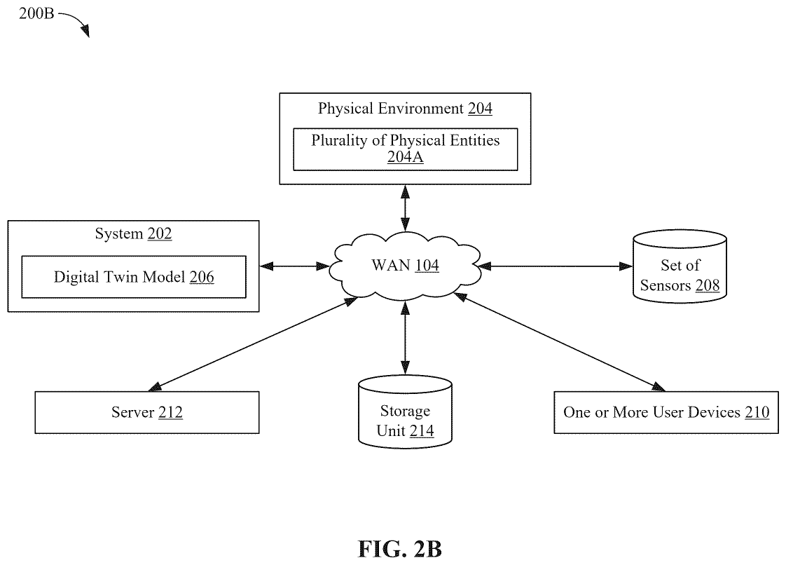

FIG. 2A is a diagram that illustrates an environment for controlling physical entities within a physical environment by re-baselining protocol data, in accordance with an embodiment of the disclosure. FIG. 2A is explained in conjunction with elements from FIG. 1. With reference to FIG. 2A, there is shown a diagram of a network environment 200A. The network environment 200A includes a system 202, a physical environment 204, and a digital twin model 206. Further, the physical environment 204 includes a plurality of physical entities 204A. The network environment 200A further includes the WAN 104 of FIG. 1. In an embodiment, the system 202 is an exemplary embodiment of the computer 102 in FIG. 1.

The system 202 may include suitable logic, circuitry, interfaces, and/or code that is configured for controlling the plurality of physical entities 204A by re-baselining protocol data. The physical environment 204 refers to a specified zone or an industrial environment where the plurality of physical entities 204A is deployed to execute one or more activities. The physical environment 204 is defined based on physical conditions and features present within the industrial environment. Further, the physical environment 204 is defined based on safety requirements and the nature of the one or more activities that the plurality of physical entities is intended to perform. For example, the physical environment 204 includes a space layout indicative of an arrangement of the plurality of physical entities 204A within the physical environment 204. For example, the physical environment 204 further includes safety equipment, safety barriers, emergency exits, and the like.

In an embodiment, each physical entity of the plurality of physical entities 204A is a physical machine implemented in the physical environment 204 to perform designated tasks or activities. The one or more activities refer to one or more manufacturing processes executed by each of the plurality of physical entities 204A within the physical environment 204. Examples of the one or more activities include various operational functions such as, but not limited to, drilling, pumping, milling, welding, material handling, cutting, assembling, packaging, and the like. In one example, the physical environment 204 may correspond to an industrial floor in a car manufacturing plant, and the plurality of physical entities 204A may be positioned within the physical environment 204. In such an example, the plurality of physical entities 204A may correspond to machines that perform one or more activities, such as welding car frames, drilling holes for components, and handling materials at different assembly stations.

The digital twin model 206 is a virtual replica of the physical environment 204, enabling simulation and analysis of each activity of the one or more activities executed by each entity physical entity of the plurality of physical entities 204A. The digital twin model 206 of the system 202, according to the present embodiment, also performs a simulation of the physical environment 204 to determine anomalies associated with one or more activities executed by at least one of the plurality of physical entities 204A within the physical environment 204 and its potential impact on remaining plurality of physical entities 204A. The system 202 utilizes Internet of Things (IoT) technology and image feeds of the physical environment 204 to analyze the one or more activities performed by each physical entity of the plurality of physical entities 204A.

The WAN 104 facilitates seamless communication between the various elements of the network environment 200A. The WAN 104 ensures efficient data transfer and coordination among the system 202, and the physical environment 204. This integrated environment enables the dynamic assessment of the anomaly associated with one or more activities of the physical entity and recalibration of the protocol data, thereby enhancing the reliability and performance of the plurality of physical entities 204A.

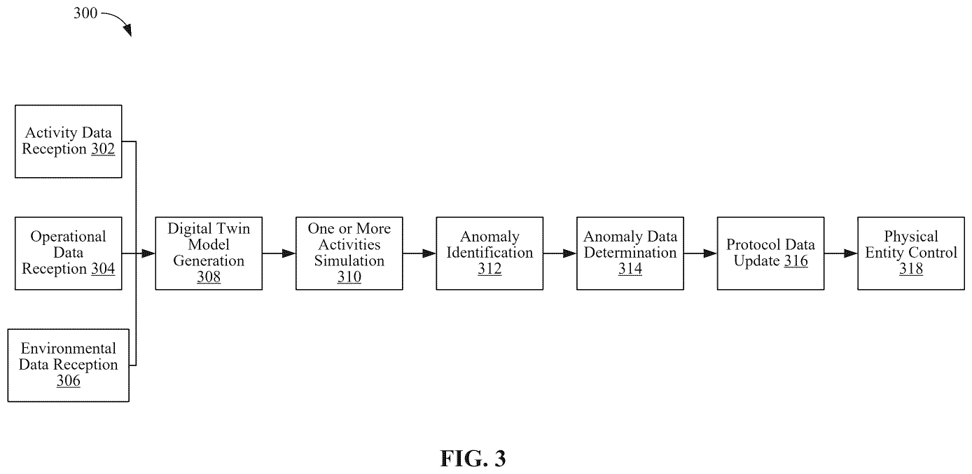

In operation, the system 202 may be configured to simulate the one or more activities of the physical environment 204 based on the digital twin model 206. For example, the simulation may facilitate mimicking and analyzing the behavior of the plurality of physical entities 204A based on the digital twin model 206, thereby reducing risks associated with the plurality of physical entities 204A performing the one or more activities in a real-world implementation. This may further improve decision-making and predict outcomes for execution of the one or more activities. Details associated with the generation and simulation of the digital twin model 206 are provided, for example, in FIG. 3.

Further, the system 202 may be configured to identify the anomaly associated with at least one of the one or more activities based on the simulation and the protocol data. The protocol data corresponds to information associated with security measures to be followed while executing operations of each physical entity of the plurality of physical entities 204A to ensure optimal reliability and performance of the plurality of physical entities 204A. This may facilitate minimizing the risks to each physical entity of the plurality of physical entities 204A, in addition to one or more users of each physical entity of the plurality of physical entities 204A and the physical environment 204. Examples of the protocol data include but are not limited to, operating parameter data associated with each physical entity of the plurality of physical entities, operating zone data associated with an operation of each physical entity of the plurality of physical entities, and movement data associated with one or more users within the physical environment.

In an embodiment, the anomaly corresponds to irregularity in the operations executed by each physical entity of the plurality of physical entities 204A. For example, the system 202 may analyze the simulation of one or more activities being performed by each of the plurality of physical entities 204A to identify an abnormality in the operations executed by at least one physical entity of the plurality of physical entities 204A. Examples of the anomaly include but are not limited to, malfunctioning of at least one of the plurality of physical entities 204A, a safety threat associated with at least one of the plurality of physical entities 204A, and a maintenance requirement associated with at least one of the plurality of physical entities 204A. Thereafter, the system 202 may be configured to determine anomaly data based on the anomaly. Details associated with the protocol data and the anomaly data are provided, for example, in FIG. 3.

Further, the system 202 is configured to update the protocol data based on the anomaly data and control at least one of the plurality of physical entities 204A based on the updated protocol data. Details associated with the update of the protocol data and the controlling of the at least one of the plurality of physical entities 204A are provided, for example, in FIG. 3.

FIG. 2B is a diagram that illustrates an exemplary environment for controlling the plurality of physical entities 204A within the physical environment 204 by re-baselining the protocol data, in accordance with an embodiment of the disclosure. FIG. 2B is explained in conjunction with elements from FIG. 1 and FIG. 2A. With reference to FIG. 2B, there is shown a diagram of a network environment 200B. The network environment 200B includes the system 202, the physical environment 204, the digital twin model 206, a set of sensors 208, one or more user devices 210, and a server 212. Further, the network environment 200 also includes a storage unit 214. The network environment 200B further includes the WAN 104 of FIG. 1. In an embodiment, the system 202 is an exemplary embodiment of the computer 102 in FIG. 1.

The system 202 obtains activity data to generate the digital twin model 206 from the set of sensors 208. The activity data may be associated with each activity of the one or more activities executed by each physical entity of the plurality of physical entities 204A. In other words, the activity data may correspond to information associated with one or more operations being performed by each physical entity of the plurality of physical entities 204A in real-time. Further, the set of sensors 208 collects the activity data in real-time at various points of interest within the physical environment 204. The set of sensors 208 includes, but may not be limited to, accelerometers, vibration sensors, strain gauges, gyroscopes, and the like.

For example, the physical environment 204 may correspond to an industrial floor of a car manufacturing plant, and the set of sensors 208 may include accelerometers and vibration sensors. In such an example, when a car frame is being welded, the accelerometers and the vibration sensors implemented within the physical environment 204 and in the vicinity of a machine executing the welding operation may detect conditions or attributes of the environment and a manner in which the machine is performing the welding operation. Such information may correspond to the activity data associated with the machine performing the welding operation. For example, such activity data may indicate excessive vibrations within the physical environment occurring during the welding operation being performed. The excessive vibrations may compromise a weld quality of the welding operation.

Further, the system 202 processes the activity data received in real-time and generates the digital twin model 206 of the physical environment 204. For example, the digital twin model 206 may correspond to a virtual model of the industrial floor of the car manufacturing plant. This may include a digital representation of each physical entity present within the physical environment 204 and the one or more activities being performed thereby. In an example, the digital twin model 206 of the physical environment 204 may include a digital twin model of each physical entity, i.e., machine, of the plurality of physical entities 204A within the physical environment 204.

To this end, the system 202 is configured to simulate the physical environment 204 based on the digital twin model 206 and the activity data. Based on the simulation using the real-time activity data, anomalies associated with the one or more activities of a physical entity in the physical environment 204 and its potential impact on other physical entities in the physical environment 204 are identified. For example, the unwanted vibrations in the physical environment 204 may be identified as an anomaly. Further, strain gauges on assembly line frames may detect a value of stress, prompting the system 202 to act to protect the physical entity and ensure consistent product quality.

Further, the system 202 obtains operational data associated with each physical entity of the plurality of physical entities 204A, and environmental data associated with the physical environment 204. Such data may be obtained from the set of sensors 208 and/or the storage unit 214. The operational data includes but is not limited to the operational parameters of each physical entity of the plurality of physical entities 204A, and safety protocols associated with the operation of each physical entity of the plurality of physical entities 204A. For example, the operational data includes information associated with working the machines present within the physical environment 204. The environmental data includes but is not limited to a layout of the physical environment 204, the plurality of physical entities 204A, or the machines implemented in the physical environment 204.

Based on the obtained data, the digital twin model 206 of the physical environment 204 is generated. The system 202 is configured to generate a behavioral model of each physical entity of the plurality of physical entities 204A. The system 202 generates the digital twin model 206 representing geometrical properties, physical properties, and mechanical properties of each physical entity of the plurality of physical entities 204A based on the obtained activity data. Further, the digital twin model 206 is simulated to develop the behavioral model which is a physics-based representation that includes the behavior of each physical entity of the plurality of physical entities 204A, modeling the mechanical properties, interactions, responses of the equipment to various forces and loads applied to the machine, and position of the center of gravity.

After the generation of the digital twin model 206, the one or more activities of the physical environment 204 are simulated for identification of an anomaly associated with at least one of the one or more activities. In an embodiment, the anomaly is identified based on the simulation and the protocol data. The digital twin model 206 obtains data collected by the set of sensors 208, historical records, or anticipated operational conditions to simulate the one or more activities. The simulation based on the digital twin model 206 facilitates the identification of the anomaly associated with a physical entity and its effect on other physical entities.

Thereafter, the system 202 determines the anomaly data associated with the anomaly based on the simulation and the protocol data. Further, the system 202 updates the protocol data based on the anomaly data, thereby minimizing the impact of the anomaly associated with the physical entity on other physical entities in the physical environment 204. The system 202 is configured to control at least one of the plurality of physical entities 204A based on the updated protocol data, thereby maintaining the reliability and performance of the plurality of physical entities 204A.

Referring to FIG. 2B, the storage unit 214 is implemented for storing data related to the digital twin model 206, activity data, operational data, and environmental data. The storage unit 214 is typically a high-speed storage medium such as a Solid-State Drive (SSD) or a Hard Disk Drive (HDD) located within the system 202. The storage unit 214 stores data required for real-time processing and simulation. For example, the data collected from the set of sensors 208 is stored in the storage unit 214. In an implementation, the storage unit 214 serves as a backup and archival storage solution, ensuring data redundancy and long-term data retention. The storage unit is configured to maintain data integrity and accessibility for ongoing operations and simulations.

The server 212 functions as a central repository for historical data and provides the computational resources to run the digital twin simulations. This server is equipped with high-performance processors, extensive memory, and large storage capacities to handle the computational demands of simulating mechanical operations and analyzing vibration impacts. The historical data refers to the accumulated information about past operations, performance metrics, and vibration patterns of the machine. The server 212 includes high-performance processors, such as multi-core Central Processing Units (CPUs) and Graphics Processing Units (GPUs), to efficiently execute algorithms and simulations. The server 212 is also equipped with a memory, including Random Access Memory (RAM) capacities, to facilitate the rapid processing of large datasets. Additionally, the server has substantial storage capacities, utilizing SSDs or HDDs, to store the historical data and the results of the simulations.

The historical data includes records of previous tasks performed by each physical entity of a plurality of physical entities 204A, the corresponding operational data associated with each physical entity of the plurality of physical entities 204A, and the corresponding environmental data associated with the physical environment 204. Such data is utilized for training the digital twin model 206, as such data enables the system 202 to predict anomalies associated with each physical entity of the plurality of physical entities 204A based on a historical simulation. By leveraging historical simulation, the system 202 can enhance the accuracy of its simulations and improve decision-making processes.

The one or more user devices 210 provide interfaces for users to interact with the system 202, monitor the status of each physical entity of the plurality of physical entities 204A, and receive recommendations associated with updated protocol data. The one or more user devices 210 can include computers, tablets, or smartphones that are connected to the WAN 104, enabling remote access and control.

The WAN 104 facilitates seamless communication between the various elements of the network environment 200B. The WAN 104 ensures efficient data transfer and coordination among the system 202, the set of sensors 208, the storage unit 214, the server 212, and the one or more user devices 210. This integrated environment enables the proactive update of the protocol data, thereby enhancing the performance and safety of the plurality of physical entities.

FIG. 3 is a block diagram that illustrates an exemplary operation for controlling the physical entities within the physical environment by re-baselining the protocol data, in accordance with an embodiment of the disclosure. FIG. 3 is explained in conjunction with elements from FIG. 1, FIG. 2A and FIG. 2B. With reference to FIG. 3, there is shown a block diagram 300 that illustrates exemplary operations from 302 to 318, as described herein. The exemplary operations illustrated in the block diagram 300 start at 302 and are performed by any computing system, apparatus, or device, such as by the computer 102 of FIG. 1 or the system 202 of FIG. 2. Although illustrated with discrete blocks, the exemplary operations associated with one or more blocks of the block diagram 300 are divided into additional blocks, combined into fewer blocks, or eliminated, depending on the particular implementation.

At 302, activity data is received. In an embodiment, the system 202 is configured to obtain activity data associated with each activity of the one or more activities executed by each physical entity of the plurality of physical entities 204A. In other words, the activity data may correspond to information associated with one or more manufacturing processes being performed by each physical entity of the plurality of physical entities 204A. Examples of the one or more manufacturing processes include various operational functions such as, but not limited to, drilling, pumping, milling, welding, material handling, cutting, assembling, packaging, and the like

At 304, operational data is received. In an embodiment, the system 202 is configured to obtain the operational data associated with each physical entity of the plurality of physical entities 204A. The operational data includes the operational parameters of each physical entity of the plurality of physical entities 204A. Examples of the operational data may include, but are not limited to, a payload of each physical entity of the plurality of physical entities 204A, work duration of each physical entity of the plurality of physical entities 204A, speed of moving parts of each physical entity of the plurality of physical entities 204A, amount of heat generated, and amount of exhaust.

At 306, environmental data is received. In an embodiment, the system 202 is configured to obtain the environmental data associated with the physical environment 204. The environmental data includes, but is not limited to, a layout of the physical environment 204, an arrangement of the plurality of physical entities 204A, or the machines implemented in the physical environment 204. Further, the environmental data includes information associated with an ambient temperature of the physical environment 204, temperature level, and noise level associated with each physical entity of the plurality of physical entities 204A.

At 308, the digital twin model 206 is generated. In an embodiment, the system 202 is configured to generate the digital twin model 206 of the physical environment 204. The digital twin model 206 includes a virtual representation of each physical entity of the plurality of physical entities 204A. The digital twin model 206 is a virtual model designed to accurately reflect each physical entity of the plurality of physical entities 204A within the physical environment. Each physical entity of the plurality of physical entities 204A that is being analyzed is equipped with the set of sensors 208 related to areas of functionality (e.g., moving parts). Such sensors generate data regarding different aspects of the physical machine's operational parameters and activities being performed, such as a type of activity performed, type and amount of energy output, temperature, environmental conditions, and the like. In an embodiment, the digital twin model 206 of the physical environment 204 is generated based on the activity data and the protocol data. Further, the digital twin model 206 of the physical environment 204 is based on the operational data and the environmental data. Such data is then provided as an input to the system 202 to generate the virtual model (i.e., the digital twin model 206).

At 310, one or more activities are simulated within the digital twin model 206. In an embodiment, the system 202 is configured to simulate the one or more activities based on the digital twin model 206 of the physical environment 204. The one or more activities are executed by each physical entity of the plurality of physical entities 204A within the physical environment 204. In response to receiving the activity data, the operational data, and the environmental data, the system 202 runs different simulations on the digital twin model 206 to determine, for example, machine operating context, machine performance under different conditions, potential incidents, incident propagation impact, and the like.

At 312, an anomaly is identified. In an embodiment, the system 202 is configured to identify the anomaly associated with at least one of the one or more activities based on the simulation and the protocol data. The protocol data includes information associated with security protocols associated with operations of each physical entity of the plurality of physical entities 204A, thereby maintaining the safety and security of each physical entity of the plurality of physical entities 204A. For example, the protocol data includes a set of rules for operations of each physical entity of the plurality of physical entities 204A, that may define various operational parameters and environmental factors associated with execution of the one or more activities. Further, the protocol data includes operating parameter data associated with each physical entity of the plurality of physical entities, operating zone data associated with an operation of each physical entity of the plurality of physical entities, and movement data associated with one or more users within the physical environment. The operating parameter data associated with each physical entity of the plurality of physical entities 204A includes operational parameters associated with each physical entity of the plurality of physical entities 204A. Examples of the operational parameters include, but are not limited to, workload or capacity associated with a physical entity, duration of work associated with the physical entity, and the like. The operating zone data corresponds to information on an operating zone associated with each physical entity of the plurality of physical entities 204A. The operating zone may be defined as a boundary that is safe for the operation of the physical entity as well as the user of the physical entity. The movement data associated with one or more users within the physical environment 204 includes information associated with the movement of the users (such as workers) within the physical environment 204. For example, the number of workers being assigned in the physical environment 204 to operate various physical entities (such as machines) safely.

In an embodiment, the system 202 is configured to analyze the simulation and a historical simulation of the one or more activities associated with each physical entity of the plurality of physical entities 204A. The historical simulation corresponds to simulation of the one or more activities over a previous period of time. Such simulation is based on historical activity data, historical environmental data, and historical operation data. The system 202 is configured to compare the simulation and the historical simulation for the analysis. For example, the simulation based on real-time data is compared with the historical simulation based on corresponding historical data to identify irregularities in the behavior of each physical entity. Such irregularities may lead to potential safety threats, thereby generating an unsafe environment for the user of each physical entity.

For example, the system 202 may employ machine learning models for the analysis and identify the anomaly. The machine learning model is a computational network or a system of artificial neurons, arranged in a plurality of layers, as nodes. The plurality of layers of the machine learning model includes an input layer, one or more hidden layers, and an output layer. Each layer of the plurality of layers includes one or more nodes (or artificial neurons). Outputs of all nodes in the input layer are coupled to at least one node of the hidden layer(s). Similarly, inputs of each hidden layer are coupled to outputs of at least one node in other layers of the machine learning model. Outputs of each hidden layer are coupled to inputs of at least one node in other layers of the machine learning model. Node(s) in the final layer receive inputs from at least one hidden layer to output a result. The number of layers and the number of nodes in each layer are determined from hyper-parameters of the machine learning model. Such hyper-parameters are set before or while training the machine learning model on a training dataset (such as the historical simulation).

Each node of the machine learning model may correspond to a mathematical function (e.g., a sigmoid function or a rectified linear unit) with a set of parameters, tunable during training of the network. The set of parameters includes, for example, a weight parameter, a regularization parameter, and the like. Each node uses the mathematical function to compute an output based on one or more inputs from nodes in other layer(s) (e.g., previous layer(s)) of the machine learning model. All or some of the nodes of the machine learning model may correspond to the same or a different mathematical function.

In training of the machine learning model, one or more parameters of each node of the machine learning model are updated based on whether an output of the final layer for a given input (from the training dataset) matches a correct result based on a loss function for the machine learning model. The above process is repeated for the same or a different input until a minima of loss function is achieved, and a training error is minimized. Several methods for training are known in art, for example, gradient descent, stochastic gradient descent, batch gradient descent, gradient boost, meta-heuristics, and the like.

The machine learning model includes electronic data, such as, for example, a software program, code of the software program, libraries, applications, scripts, or other logic or instructions for execution by a processing device, such as a processor set. The machine learning model includes code and routines configured to enable a computing device, such as the system 202, to perform one or more operations. Additionally, or alternatively, the machine learning model is implemented using hardware including a processor, a microprocessor (e.g., to perform or control performance of the one or more operations), a field-programmable gate array (FPGA), or an application-specific integrated circuit (ASIC). Alternatively, in some embodiments, the machine learning model is implemented using a combination of hardware and software. For example, the machine learning model is integrated within the system 202. In another example, the machine learning model can be a separate entity from the system 202. In an embodiment, the machine learning model is stored in the server 212. Examples of the machine learning model may include, but are not limited to, a deep neural network (DNN), a convolutional neural network (CNN), a CNN-recurrent neural network (CNN-RNN), an artificial neural network (ANN), a fully connected neural network, and/or a combination of such networks.

In an embodiment, the system 202 is configured to determine deviation data associated with the simulation based on the analysis of the simulation and the historical simulation. The deviation data includes information associated with a variation (or irregularities) in the operational behavior of each physical entity from historical behavior and protocol data. Such a deviation facilitates identification of the anomaly associated with at least one of the one or more activities. Examples of the anomaly include, but are not limited to, malfunctioning of at least one of the plurality of physical entities, a safety threat associated with at least one of the plurality of physical entities, and a maintenance requirement associated with at least one of the plurality of physical entities. The malfunctioning of at least one of the plurality of physical entities corresponds to a failure in the physical entity while performing the one or more activities. The safety threat associated with at least one of the plurality of physical entities corresponds to warnings associated with the safety or security of the physical entity based on a variation in the operational parameters or environmental conditions. The maintenance requirement associated with at least one of the plurality of physical entities corresponds to the repair or protection needed for the efficient and reliable performance of the physical entity.

At 314, anomaly data is determined. In an embodiment, the system 202 is configured to determine the anomaly data associated with the anomaly based on the simulation and the protocol data. The anomaly data corresponds to a collation of information associated with the anomaly identified while each physical entity is performing the one or more activities. In an embodiment, the system 202 is configured to determine the anomaly data associated with the anomaly based on the deviation data.

At 316, protocol data is updated. In an embodiment, the system 202 is configured to update the protocol data based on the anomaly data. In response to the determination of the anomaly data, the system 202 updates the protocol data to minimize the impact of the identified anomaly, thereby facilitating reliable performance of the plurality of physical entities 204A. The updated protocol data includes recalibrated safety protocols based on the identified anomaly. Further, the updated protocol data includes at least one of the updated operating parameter data associated with each physical entity of the plurality of physical entities, updated operating zone data associated with an operation of each physical entity of the plurality of physical entities, or updated movement data associated with one or more users within the physical environment.

Further, the machine learning model may be trained based on the historical simulation, historical anomalies, and corresponding protocol data updates, thereby improving the ability of the system 202 to predict and optimally respond to safety threats. For example, the system 202 may leverage the use of a machine learning model to dynamically update the protocol data based on the identified anomaly. Further, the system 202 may predict the potential safety threats based on the analysis of the simulation, and the historical data. For example, the system 202 may identify an anomaly in a machine ‘A’. Further, the machine learning model may predict that there may be a safety concern for a machine ‘B’ based on the historical simulation analysis, thereby recommending a decrease in workload for the machine ‘B’ as an update in the protocol data. This may facilitate an optimal and safe working environment for the one or more users in the physical environment.

At 318, a physical entity from the plurality of physical entities 204A is controlled. In an embodiment, the system 202 is configured to control at least one of the plurality of physical entities 204A based on the updated protocol data. The system 202 controls the plurality of physical entities 204A to perform the one or more activities based on the updated protocol data. For example, an operation of the machine ‘B’ performing the one or more activities (such as pumping liquid) may be terminated based on the updated protocol data, thereby avoiding a potential safety threat (such as complete failure) of the machine ‘B’ based on the identified anomaly in the machine ‘A’.

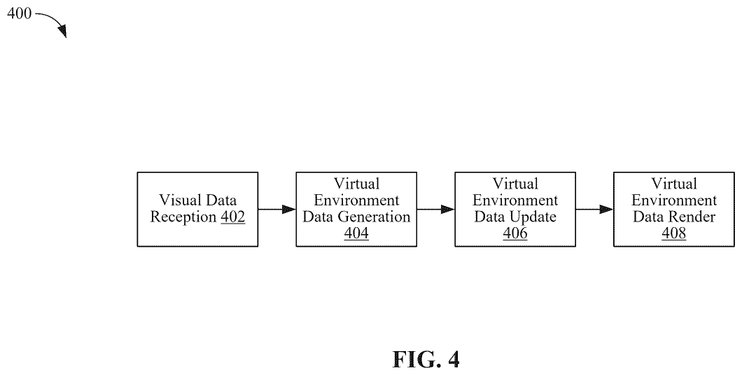

FIG. 4 is a block diagram that illustrates an exemplary operation for rendering virtual environment data based on the updated protocol data, in accordance with an embodiment of the disclosure. FIG. 4 is explained in conjunction with elements from FIG. 1, FIG. 2A, FIG. 2B and FIG. 3. With reference to FIG. 4, there is shown a block diagram 400 that illustrates exemplary operations from 402 to 408, as described herein. The exemplary operations illustrated in the block diagram 400 start at 402 and are performed by any computing system, apparatus, or device, such as by the computer 102 of FIG. 1 or the system 202 of FIG. 2. Although illustrated with discrete blocks, the exemplary operations associated with one or more blocks of the block diagram 400 are divided into additional blocks, combined into fewer blocks, or eliminated, depending on the particular implementation.

At 402, visual data is received. In an embodiment, the system 202 is configured to obtain the visual data associated with the physical environment 204. The visual data includes object data associated with each physical entity of the plurality of physical entities 204A. In an embodiment, the system 202 obtains the visual data of the plurality of physical entities 204A present in the physical environment 204. The visual data includes one or more images or video data of the physical environment 204 in real-time. The system 202 may be configured to receive the one or more images or video data of the real-world environment using an image-capturing device such as a camera. The visual data may be obtained based on one or more image processing algorithms, such as object detection algorithms, deep learning algorithms, and other methods that may be known to one ordinarily skilled in the art.

At 404, virtual environment data is generated. In an embodiment, the system 202 is configured to generate virtual environment data based on the visual data and the digital twin model 206. The virtual environment data includes a virtual representation of the execution of each activity of the one or more activities. The virtual environment data corresponds to digital information that may define the visual component of each physical entity of the plurality of physical entities 204A. This may facilitate generating an immersive and interactive experience for the one or more users.

Further, the system 202 generates the virtual environment data in association with at least one physical entity of the plurality of physical entities 204A present in the physical environment 204 based on the visual data. For example, the system 202 may generate the virtual environment data based on the one or more images or video data. The process may involve processes such as but not limited to three-dimensional modeling, computer vision, and machine learning. For example, the system 202 may leverage the use of computer vision techniques to convert a two-dimensional image or video data into a three-dimensional virtual environment, thereby generating the interactive virtual environment data.

For example, if the physical entity is a drilling machine in a manufacturing plant, the system 202 may obtain visual data associated with the drilling machine that may include the physical appearance of the drilling machine, and an arrangement of the drilling machine within the physical environment 204. Thereafter, the system 202 generates the virtual environment data based on the visual data that may include a three-dimensional model of the drilling machine in the physical environment 204.

For example, if the physical entity is a user or worker working in the vicinity of the drilling machine within the physical environment 204, the system 202 obtains visual data associated with the user that may include the physical appearance of the user and the presence of the user within the physical environment 204. Thereafter, the system 202 generates the virtual environment data associated therewith, for example, a virtual avatar of the user.

In an embodiment, the system 202 is configured to render the virtual environment data on a user device. Upon capturing the visual data of the physical environment 204, various computer vision techniques such as motion capture may be implemented to track the movement of the camera in the real-time. Thereafter, the virtual environment data may be overlayed onto the live video data to create an immersive experience for the user.

At 406, virtual environment data is updated. In an embodiment, the system 202 is configured to update the virtual environment data based on the updated protocol data. For example, based on the updated protocol data, the system 202 may control at least one of the plurality of physical entities 204A in response to the identified anomaly. Further, the system 202 may dynamically update the virtual environment data for the user.

In an embodiment, the system 202 dynamically updates physical security measures based on the updated protocol data. This may involve access control systems, entry limitations, and worker skill verification. The system 202 enforces access control policies that may restrict entry to specific areas based on the updated protocol data, thereby implementing limitations on the number of users allowed in the physical environment 204, ensuring it does not exceed predefined thresholds. The system 202 may be integrated with the skills and qualifications of workers before granting access to certain areas. This could involve authentication mechanisms, such as biometrics or smart cards, and may ensure that the system complies with safety and security regulations and standards in the physical environment 204.

At 408, virtual environment data is rendered. In an embodiment, the system 202 is configured to render the updated virtual environment data on the user device. For example, the system 202 dynamically adjusts virtual environment data for one or more users based on the updated protocol data in the physical environment 204. Thereafter, the system 202 integrates the updated protocol data, real-time tracking of the user, and safety parameters to the virtual environment data, thereby generating an augmented reality (AR) for the users that can dynamically adjust based on the re-baselined protocol data. This may facilitate the user to visualize the changes in mobility areas within the physical environment 204, unsafe areas within the physical environment 204, and virtual avatars of the user. The system 202 may leverage the use of the virtual environment data to train the users, thereby acquainting the users with the updated protocol data.

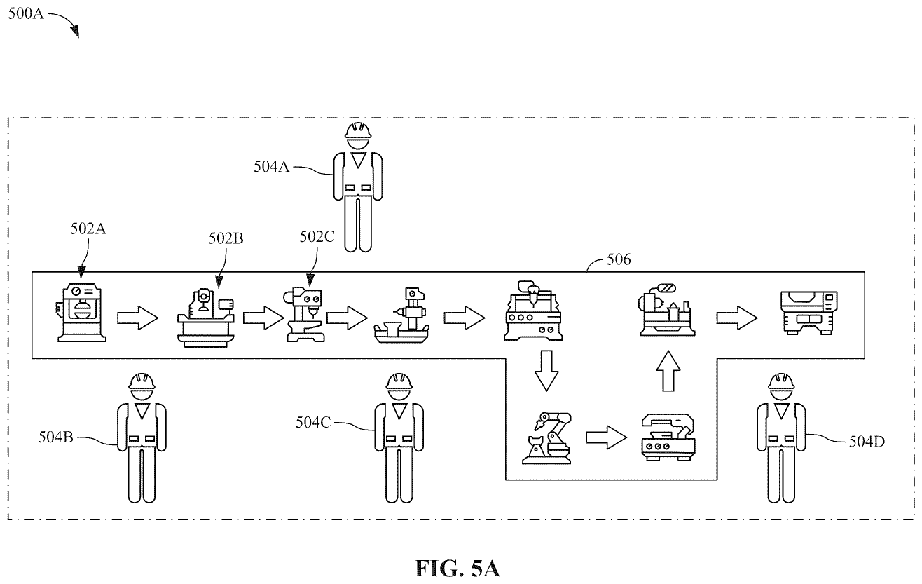

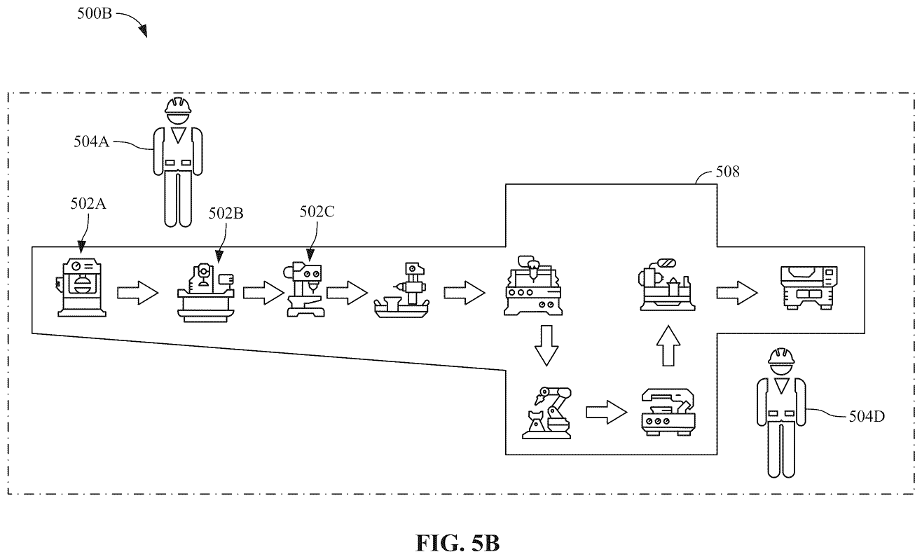

FIG. 5A is a diagram that illustrates an exemplary diagram of virtual environment data associated with the physical environment, in accordance with an embodiment of the disclosure. FIG. 5A is explained in conjunction with elements from FIG. 1, FIG. 2A, FIG. 2B, FIG. 3, and FIG. 4. With reference to FIG. 5A, there is shown an exemplary diagram 500A of an industrial environment including the plurality of physical entities for example, a plurality of machines such as but not limited to a first machine 502A, a second machine 502B, and a third machine 502C. Further, the industrial environment includes one or more users such as a first user 504A, a second user 504B, a third user 504C, and a fourth user 504D.

In operation, the industrial environment may have a set of sensors (such as the set of sensors 208) and monitoring devices throughout an industrial floor to collect real-time data on machine performance, environmental conditions, safety parameters, and security systems. Further, based on the sensor data and the visual data of the industrial environment, the system 202 generates a digital twin model 206. Further, the system 202 simulates the one or more manufacturing processes of each machine of the plurality of machines (such as the first machine 502A, the second machine 502B, and the third machine 502C) based on the digital twin model 206. Thereafter, the system 202 analyzes the simulation and the historical simulation to identify anomalies, predict maintenance needs, and potential safety threats for the plurality of machines (such as the first machine 502A, the second machine 502B, and the third machine 502C). In response to the detected anomalies with at least one machine (such as the first machine 502A) on the industrial floor, the system 202 is configured to dynamically recalibrate or re-baseline the protocol data for the industrial floor, while simultaneously adjusting operational parameters for the affected first machine 502A and their immediate operational environment. This adaptive approach ensures that any safety threats are promptly mitigated.

Further, the system 202 performs an analysis of historical simulation, the workflow of various manufacturing processes, the involvement of the plurality of machines, and the quality of the work product. Based on the historical data and digital simulation, the system 202 may detect anomalies in machine behavior, such as unusual vibrations, temperature spikes, or unexpected changes in energy consumption. For example, in response to the detected anomalies with at least one machine (such as the first machine 502A) on the industrial floor, the system 202 is configured to assess shared resources, potential chain reactions, delayed response, and other pertinent factors to determine an impact of the identified anomaly on the remaining plurality of machines (such as the second machine 502B, and the third machine 502C). These anomalies could indicate potential issues with the third machine 502C.

Further, the historical data includes machine performance data, maintenance records, incident reports, and other relevant sensor data. This data can come from various sources like IoT sensors, and historical records. Based on the one or more manufacturing processes, the system 202 may use simulation of the digital twin model 206 to understand the dependencies and interactions between the plurality of machines to understand workflow and potential chain reactions. If the first machine 502A malfunctions, it might affect the remaining plurality of machines (such as the second machine 502B, and the third machine 502C) in the vicinity. Further, the system 202 identifies the impact based on overload, propagation of vibration, increase in payload, and changes in the propagated information.

The system 202 may use the machine learning model to assess the severity of identified anomalies and potential safety threats based on the simulation, and the protocol data, thereby determining the impact on human safety, production efficiency, and the physical environment 204. Further, the machine learning model and data analysis algorithms perform historical analysis to identify patterns, anomalies, and correlations in the data (such as the activity data, the operational data, and the environmental data) related to machine behavior and safety. For example, the system 202 may conduct the digital twin model 206 simulation to identify the anomaly in the first machine 502A, which can trigger safety issues in the third machine 502C within the industrial floor. Thereafter, the system 202 may dynamically update the protocol data and enforce such re-baselined protocol data for the industrial floor to ensure the safety of the plurality of machines, and the one or more users. Further, the system 202 may leverage the use of a machine learning model to adapt material flow, human movement, and operational parameters of the plurality of machines to align with the updated protocol data. The system 202 may analyze the re-baselined protocol data of the industrial floor using the virtual environment data. Using digital twin simulation, the system 202 may determine whether a supplementary security system should be temporarily installed in the industrial environment and for the workers. This approach allows the activity to proceed without significantly altering the existing protocol data. Such dynamic recalibration of the protocol data based on the threat assessment may involve adjusting access control, shutting down specific areas, or reconfiguring network security in response to detected anomalies, based on identified anomalies with the plurality of machines, and the protocol data (such as security guidelines).

After re-baselining the protocol data on the industrial floor, the virtual environment data may dynamically adjust the visualization of the modified protocol data may be rendered on the one or more user devices 210. This may include displaying changes in mobility areas, unsafe areas, and paths, and incorporating virtual avatars to offer guidance regarding the updated protocol data. This approach facilitates a rapid adaptation by the one or more users (workers) to the re-baselined protocol data. For example, based on the simulation result, and the propagated input parameters to different machines, the system 202 simulates each machine to identify what operational parameters are to be used for the affected machines to minimize safety risks and production interruptions. This could include reducing payloads, altering work duration, or adjusting speed.

In an embodiment, the system 202 performs digital simulation to test the proposed adjustments before implementing them in the real environment. This helps ensure that the changes may have the desired effect without creating new issues. Further, based on the identified anomalies with the plurality of machines within the workflow, the system 202 may perform a series of digital twin simulations to identify what types of protocol data are to be changed to ensure the same level of safety for the one or more users in the industrial floor.

In an embodiment, the system 202 generates the digital twin model 206 for machines and the overall industrial floor. Such a model replicates the behavior and interaction of machines, material flow, human movement, and safety protocols. Further, the system 202 dynamically re-baselines protocol data when the anomaly is identified. This involves altering access control, system permissions, and other security measures, as necessary. In an embodiment, the system 202 is configured to determine an operating zone 506 associated with the operation of each machine entity of the plurality of machines based on the operating zone data.

FIG. 5B is a diagram that illustrates an exemplary diagram of the virtual environment data associated with the physical environment, in accordance with an embodiment of the disclosure. FIG. 5B is explained in conjunction with elements from FIG. 1, FIG. 2A, FIG. 2B, FIG. 3, FIG. 4, and FIG. 5A. With reference to FIG. 5B, there is shown an exemplary diagram 500B of an updated operating zone 508 associated with the operation of each machine of the plurality of machines based on the updated protocol data.

Once the re-baselined protocol data is established for the industrial floor, the system 202 dynamically updates the physical security measures within the industrial floor. This may involve restricting access to specific types of workers that may be lacking the necessary skills, as well as enforcing limitations on the number of workers allowed to enter the industrial environment, ensuring that it does not exceed a predefined threshold. The system 202 may monitor, in real time, the historical data corpus of learnings and insights from past protocol data adjustments. The system may recognize patterns that may emerge and incorporate automation of a fix when a pattern has been repeated over time.

In an embodiment, the system 202 determines the distance of the one or more users from the operating zone based on the movement data, and identifies the anomaly based on the distance. For example, when the distance between the updated operating zone 508 and the second user 504B is less than a threshold, the system 202 determines an interaction between the machine and the user. This may imply an anomaly identification based on the distance, thereby indicating a safety threat to the worker. For example, if the anomaly is identified with the first machine 502A and the first user 504A moves within the vicinity of the operating zone of the first machine 502A, this may impose a safety threat for the first user 504A. Therefore, the system 202 may identify the anomaly associated therewith, and recommend the first user 504A to leave the operating zone associated with the first machine 502A. Referring to FIG. 5B, there is shown, the updated operating zone 508 associated with the operation of each machine entity of the plurality of machines based on the identified anomaly associated with the first machine 502A. Further, the number of workers is restricted for the user safety to eliminate any potential threat to the one or more users.

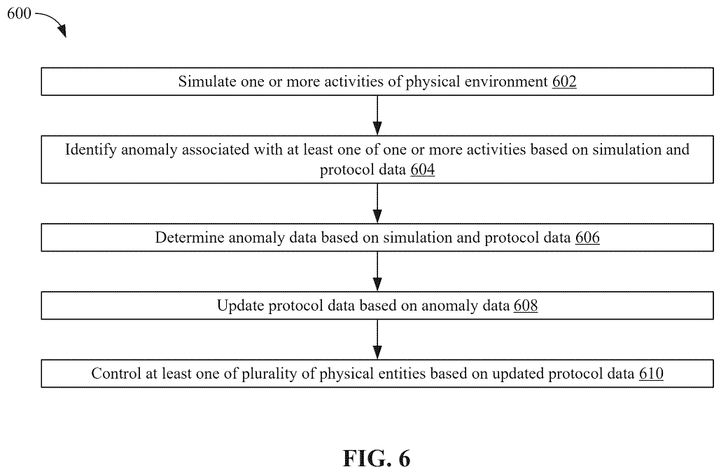

FIG. 6 is a flow chart that illustrates an exemplary method for controlling the physical entities for re-baselining the protocol data, in accordance with an embodiment of the disclosure. FIG. 6 is explained in conjunction with elements from FIG. 1, FIG. 2, FIG. 3, FIG. 4, FIG. 5A, and FIG. 5B. With reference to FIG. 6, there is shown flowchart 600. The operations of the exemplary method are executed by any computing system, for example, by the computer 102 of FIG. 1 or the system 202 of FIG. 2. The operations of the flowchart 600 may start at 602.

At 602, one or more activities of a physical environment are simulated. In an embodiment of the disclosure, the system 202 is configured to simulate the one or more activities of the physical environment 204. The simulation is based on the digital twin model 206 of the physical environment 204. The one or more activities are executed by each physical entity of the plurality of physical entities 204A within the physical environment 204. Details associated with the one or more activities are described, for example, in FIG. 1 and FIG. 3.

At 604, an anomaly is identified. In an embodiment of the disclosure, the system 202 is configured to identify the anomaly associated with at least one of the one or more activities based on the simulation and the protocol data. Details associated with the identification of the anomaly are described, for example, in FIG. 3.

At 606, anomaly data associated with the anomaly is determined based on the simulation and the protocol data. In an embodiment of the disclosure, the system 202 is configured to determine the anomaly data associated with the anomaly based on the simulation and the protocol data. The anomaly is associated with at least one of the one or more activities. Details about anomaly data are provided, for example, in FIG. 3.

At 608, the protocol data is updated based on the anomaly data. In an embodiment of the disclosure, the system 202 is configured to update the protocol data based on the anomaly data. Details associated with the update of the protocol data are described, for example, in FIG. 3.

At 610, at least one of the plurality of physical entities is controlled based on the updated protocol data. In an embodiment of the disclosure, the system 202 is configured to control at least one of the plurality of physical entities 204A based on the updated protocol data.

While the above steps shown in FIG. 6 are described in a particular sequence, the steps may occur in variations to the sequence in accordance with various embodiments of the present disclosure. Further, details related to various steps of FIG. 6, which are already covered in the description related to FIG. 1 to FIG. 5, are not discussed again in detail here for the sake of brevity.

Various embodiments of the disclosure may provide a non-transitory computer-readable medium and/or storage medium having stored thereon, instructions executable by a machine and/or a computer to operate a system (e.g., the system 202) for controlling physical entities for re-baselining protocol data. The instructions cause the machine and/or computer to perform operations that include simulating one or more activities of the physical environment 204 based on the digital twin model 206 of the physical environment 204. The one or more activities are executed by each physical entity of the plurality of physical entities 204A within the physical environment 204. The operations further include identifying the anomaly associated with at least one of the one or more activities based on the simulation and protocol data. The operations further include determining anomaly data associated with the anomaly based on the simulation and protocol data. The operations include update the safety protocol data based on the anomaly data. Further, the operations include control of at least one of the plurality of physical entities 204A based on the updated protocol data.

The descriptions of the various embodiments of the disclosure have been presented for purposes of illustration but are not intended to be exhaustive or limited to the embodiments disclosed. Many modifications and variations may be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
simulating, by a computer, one or more activities of a physical environment based on a digital twin model of the physical environment, wherein the one or more activities are executed by each physical entity of a plurality of physical entities within the physical environment;
identifying, by the computer, an anomaly associated with at least one of the one or more activities based on the simulation and protocol data;
determining, by the computer, anomaly data associated with the anomaly based on the simulation and the protocol data;
updating, by the computer, the protocol data based on the anomaly data; and
controlling, by the computer, at least one of the plurality of physical entities based on the updated protocol data.

2. The computer-implemented method of claim 1, further comprising:
obtaining, by the computer, activity data associated with each activity of the one or more activities executed by each physical entity of the plurality of physical entities;
generating, by the computer, the digital twin model of the physical environment based on the activity data and the protocol data, wherein the digital twin model comprises a virtual representation of each physical entity of the plurality of physical entities; and
simulating, by the computer, each activity of the one or more activities based on the activity data and the digital twin model.

3. The computer-implemented method of claim 1, further comprising:
obtaining, by the computer, operational data associated with each physical entity of the plurality of physical entities;
obtaining, by the computer, environmental data associated with the physical environment; and
generating, by the computer, the digital twin model of the physical environment based on the operational data and the environmental data.

4. The computer-implemented method of claim 1, further comprising:
analyzing, by the computer, the simulation, and a historical simulation of the one or more activities of the physical environment;
determining, by the computer, deviation data associated with the simulation based on the analysis; and
determining, by the computer, the anomaly data associated with the anomaly based on the deviation data.

5. The computer-implemented method of claim 1, wherein the anomaly is associated with at least one of malfunctioning of at least one of the plurality of physical entities, a safety threat associated with at least one of the plurality of physical entities, and a maintenance requirement associated with the at least one of the plurality of physical entities.

6. The computer-implemented method of claim 1, wherein the protocol data comprises operating parameter data associated with each physical entity of the plurality of physical entities, operating zone data associated with an operation of each physical entity of the plurality of physical entities, and movement data associated with one or more users within the physical environment.

7. The computer-implemented method of claim 6, further comprising:
determining, by the computer, an operating zone associated with the operation of each physical entity of the plurality of physical entities based on the operating zone data;
determining, by the computer, a distance of the one or more users from the operating zone based on the movement data;
identifying, by the computer, the anomaly based on the distance; and
determining, by the computer, the anomaly data based on the anomaly.

8. The computer-implemented method of claim 1, wherein the updated protocol data comprises at least one of updated operating parameter data associated with each physical entity of the plurality of physical entities, updated operating zone data associated with an operation of each physical entity of the plurality of physical entities, or updated movement data associated with one or more users within the physical environment.

9. The computer-implemented method of claim 1, further comprising:
obtaining, by the computer, visual data associated with the physical environment, wherein the visual data comprises object data associated with each physical entity of the plurality of physical entities;
generating, by the computer, virtual environment data based on the visual data and the digital twin model, wherein the virtual environment data comprises a virtual representation of the execution of each activity of the one or more activities; and
rendering, by the computer, the virtual environment data on a user device.

10. The computer-implemented method of claim 9, further comprising:
updating, by the computer, the virtual environment data based on the updated protocol data; and
rendering, by the computer, the updated virtual environment data on the user device.

11. The computer-implemented method of claim 1, wherein the plurality of physical entities within the physical environment corresponds to a plurality of machines within an industrial environment.

12. A computer system, comprising:
a processor set;
one or more computer-readable storage media; and
program instructions stored on the one or more computer-readable storage media, the program instructions executable by the processor set to cause the processor set to:
simulate one or more manufacturing processes of an industrial environment based on a digital twin model of the industrial environment, wherein the one or more manufacturing processes are executed by each machine of a plurality of machines within the industrial environment;
identify an anomaly associated with at least one of the one or more manufacturing processes based on the simulation and protocol data;
determine anomaly data associated with the anomaly based on the simulation and the protocol data;
update the protocol data based on the anomaly data; and
control at least one of the plurality of machines based on the updated protocol data.

13. The computer system of claim 12, wherein the program instructions further cause the processor set to:
obtain manufacturing process data associated with each manufacturing process of the one or more manufacturing processes executed by each machine of the plurality of machines;
generate the digital twin model of the industrial environment based on the manufacturing process data and the protocol data, wherein the digital twin model comprises a virtual representation of each machine of the plurality of machines; and
simulate each manufacturing process of the one or more manufacturing processes based on the manufacturing process data and the digital twin model.

14. The computer system of claim 12, wherein the program instructions further cause the processor set to:
obtain operational data associated with each machine of the plurality of machines;
obtain environmental data associated with the industrial environment; and
generate the digital twin model of the industrial environment based on the operational data and the environmental data.

15. The computer system of claim 12, wherein the program instructions further cause the processor set to:
analyze the simulation and a historical simulation;
determine deviation data associated with the simulation based on the analysis; and
determine the anomaly data associated with the anomaly based on the deviation data.

16. The computer system of claim 12, wherein the protocol data comprises operating parameter data associated with each machine of the plurality of machines, operating zone data associated with an operation of each machine of the plurality of machines, and movement data associated with one or more users within the industrial environment.

17. The computer system of claim 16, wherein the program instructions further cause the processor set to:
determine an operating zone associated with the operation of each machine of the plurality of machines based on the operating zone data;
determine a distance of the one or more users from the operating zone based on the movement data;
identify the anomaly based on the distance; and
determine the anomaly data based on the anomaly.

18. The computer system of claim 12, wherein the program instructions further cause the processor set to:
obtain visual data associated with the industrial environment, wherein the visual data comprises object data associated with each machine of the plurality of machines;
generate virtual environment data based on the visual data and the digital twin model, wherein the virtual environment data comprises a virtual representation of the execution of each manufacturing process of the one or more manufacturing processes; and
render the virtual environment data on a user device.

19. The computer system of claim 18, wherein the program instructions further cause the processor set to:
update the virtual environment data based on the updated protocol data; and
render the updated virtual environment data on the user device.

20. A computer-program product for controlling a plurality of physical entities, the computer-program product comprising:
one or more computer-readable storage media; and
program instructions stored on the one or more computer-readable storage media to perform operations comprising:
simulating one or more activities of a physical environment based on a digital twin model of the physical environment, wherein the one or more activities are executed by each physical entity of the plurality of physical entities within the physical environment;
identifying an anomaly associated with at least one of the one or more activities based on the simulation and protocol data;
determining anomaly data associated with the anomaly based on the simulation and the protocol data;
updating the protocol data based on the anomaly data; and
controlling at least one of the plurality of physical entities based on the updated protocol data.
